(19) United States
(12) Patent Application Publication
(10) Pub. No.: US 2026/0343447 A1
(43) Pub. Date: Oct. 29, 2026

(54) NETWORK TIME SYNCHRONIZATION

(71) Applicant: Telefonaktiebolaget LM Ericsson (publ), Stockholm (SE)

(72) Inventors: Mårten Wahlström, Hägersten (SE); Mikael Johansson, Solna (SE)

(21) Appl. No.: 19/491,137

(22) PCT Filed: Jun. 16, 2023
(86) PCT No.: PCT/EP2023/066225

§ 371 Date: Dec. 8, 2025

(51) Int. Cl. H04W 56/00

(52) U.S. Cl. CPC H04W 56/0015

(57) ABSTRACT

A method of time synchronization in a telecommunications system between a distributed unit (DU) and a remote unit (RU) connected by a communications interface, is presented. The method comprises obtaining, by the DU, a clock time provided by the RU via a clock distribution protocol, and synchronizing a DU clock to the clock time provided by the RU.

### TECHNICAL FIELD

The present disclosure relates to time synchronization in a network and more precisely to a time synchronization between a distributing unit and a remote unit of a telecommunications system.

### BACKGROUND

A telecommunications base station (BS), may, particularly in the context of 5G, be described as comprising a Radio Unit (RU) and a distributed unit (DU).

The RU, also known as Remote Radio Head (RRH) or Remote Radio Unit (RRU) or Remote Unit, is responsible for the radio transmission and reception in a BS. The RU generally comprises antennas and radio frequency (RF) components that communicate with network nodes e.g., user equipment (UE) such as mobile devices etc., over an air interface. The RU is usually located at a cell site or tower, proximal to antennas, and it advantageously connects to the DU using a high-speed data link.

The DU, also known as Centralized Baseband Unit (BBU), is responsible for baseband processing functions at the BS. The DU handles tasks such as signal processing, modulation/demodulation, resource allocation, and management of one or more RUs. The DU is generally located at a central location, such as a network data center. The DU may also host further functions of the BS such as control and management functions.

The DU and RU are synchronous with each other in order to support BS transmissions in defined downlink slots and to be able to schedule a UE to transmit in specific uplink slots. There are challenges in ensuring DU and RU synchronization, for instance, the O-RAN Control, User and Synchronization Plane Specification attempts at addressing at least a few of the challenges by introducing four architectures called O-LLS C1-C4. These architectures address some of the challenges but there is room for improvement, specifically when the DU executes as a SW application on a Common Off The Shelf (COTS) server.

### SUMMARY

It is in view of the above considerations and others that the various embodiments of this disclosure have been made. The present disclosure therefor recognizes the fact that there is a need for improvement of the existing art described above.

An object of the present disclosure is to provide a new type of time synchronization in a telecommunications system. Advantageously, the new type of time synchronization is improved over prior art and eliminates or at least mitigates one or more of the drawbacks discussed above. More specifically, an object of the invention is to provide time synchronization that is reliable and cost effective when parts of the telecommunications system are SW implemented functions run on Common Off The Shelf (COTS) servers. These objects are addressed by the technology set forth in the appended independent claims with preferred embodiments defined in the dependent claims related thereto.

In a first aspect, a method of time synchronization in a telecommunications system between a distributed unit, DU, and a remote unit, RU, is presented. The DU and RU are connected by a communications interface. The method comprises obtaining, by the DU, a clock time provided by the RU via a clock distribution protocol, and synchronizing a DU clock to the clock time provided by the RU.

In some embodiments, the clock time is synchronized to an air interface clock of the RU. This is beneficial as it allows for direct synchronization to tightly specified timing of radio frames etc.

In some embodiments, the clock time is obtained based on system frame number, SFN, values. This is beneficial as the SFN values are linked to radio frames and timing may be accurately determined based on these. Further, as accuracy requirements of the DU clock may be relaxed compared to accuracy requirement of the RU clock, the SFN values provide sufficient accuracy for synchronization of the DU clock.

In some embodiments, at least two different SFN values associated with a same data packet are obtained and the method further comprises determining an UL temporal delay and a DL temporal delay of the communications interface based on the at least two different SFN values.

In some embodiments, the UL temporal delay is determined independently of the DL temporal delay and the DL temporal delay is determined independently of the UL temporal delay. This is beneficial as there may be discrepancy in UL and DL delays that may be compensated by determining the temporal delays independently of each other.

In some embodiments, the method further comprises synchronizing, by the RU, the air interface clock to a reference clock.

In some embodiments, the air interface clock is synchronized to the reference clock via a precision time protocol.

In some embodiments, the air interface clock is synchronized to the reference clock via ITU-T PTP profile G.8275.1.

In some embodiments, the reference clock is a grandmaster clock.

In some embodiments, the air interface clock is synchronized to the reference clock via a direct interface of the RU.

In some embodiments, the reference clock is obtained from a GNSS receiver of the RU.

In some embodiments, the method further comprises monitoring a buffer status of the RU, and controlling a transmission rate of the communications interface based on the buffer status. This is beneficial as it reduces a risk of issues with RU buffer under-flow or over-flow.

In some embodiments, the method is a computer-implemented method.

In a second aspect, a DU operatively connected to an RU by a communications interface is presented. The DU comprises a DU clock processing circuitry configured to cause obtaining of a clock time provided by the RU via a clock distribution protocol, and synchronizing of the DU clock to the clock time provided by the RU.

In some embodiments, the clock time is an air interface clock of the RU. This is beneficial as it allows for direct synchronization to tightly specified timing of radio frames etc.

In some embodiments, the clock time is obtained based on system frame number, SFN values. This is beneficial as the SFN values are linked to radio frames and timing may be accurately determined based on these. Further, as accuracy requirements of the DU clock may be relaxed compared to accuracy requirement of the RU clock, the SFN values provide sufficient accuracy for synchronization of the DU clock.

In some embodiments, the processing circuitry is further configured to cause determining of an UL temporal delay and a DL temporal delay of the communications interface based on the at least two different SFN values. This is beneficial as there may be discrepancy in UL and DL delays that may be compensated by determining the temporal delays independently of each other.

In some embodiments, the processing circuitry is further configured to cause monitoring of a buffer status of the RU, and controlling of a transmission rate of the communications interface based on the buffer status. This is beneficial as it reduces a risk of issues with RU buffer under-flow or over-flow.

In some embodiments, the processing circuitry is forming part of a computer system.

In some embodiments, the computer system is a cloud based computer system.

In a third aspect, a radio base station is presented. The radio base station comprises the DU of the second aspect and an RU operatively connected to the DU by a communications interface.

In a fourth aspect, a telecommunications system is presented. The telecommunications system comprises processing circuitry, a DU and an RU connected by a communications interface, wherein the processing circuitry is configured to perform the method of the first aspect.

In one embodiment, the DU is the DU of the second aspect.

In a fifth aspect, a computer program product is presented. The computer program product comprises a non-transitory computer readable medium, having thereon a computer program comprising program instructions. The computer program is loadable into a processing circuitry unit and configured to cause execution of the method according to the first aspect when the computer program is run by the processing circuitry.

### BRIEF DESCRIPTION OF THE DRAWINGS

These and other aspects, features and advantages will be apparent and elucidated from the following description of various embodiments; references being made to the appended diagrammatical drawings which illustrate non-limiting examples of how the concept can be reduced into practice.

FIG. 1A is a schematic view of a telecommunications system according to some embodiments of the present disclosure;

FIG. 1B is a schematic view of a telecommunications system according to some embodiments of the present disclosure;

FIG. 1C is a schematic view of a telecommunications system according to some embodiments of the present disclosure;

FIG. 2 is a schematic view of a time synchronization in a telecommunications system according to O-LLS-C1;

FIG. 3 is a schematic view of a time synchronization in a telecommunications system according to O-LLS-C2;

FIG. 4 is a schematic view of a time synchronization in a telecommunications system according to O-LLS-C3;

FIG. 5 is a schematic view of a time synchronization in a telecommunications system according to O-LLS-C4;

FIG. 6 is a schematic view of a time synchronization in a telecommunications system according to some embodiments of the present disclosure;

FIG. 7 is a schematic view of a time synchronization in a telecommunications system according to some embodiments of the present disclosure;

FIG. 8 is a block diagram a packet according to some embodiments of the present disclosure;

FIG. 9 is a block diagram a method for time synchronization in a telecommunications system according to some embodiments of the present disclosure;

FIG. 10 is a block diagram of a telecommunications system according to some embodiments of the present disclosure;

FIG. 11 is a block diagram of a computer system according to some embodiments of the present disclosure;

FIG. 12 is a schematic view of a computer program product according to some embodiments of the present disclosure;

FIG. 13 is a schematic view of loading a computer program product onto a computer system according to some embodiments of the present disclosure;

FIG. 14 is a schematic view of loading a computer program product onto a processing circuitry according to some embodiments of the present disclosure; and

FIG. 15 is a schematic view of loading a computer program product onto a processing circuitry according to some embodiments of the present disclosure.

### DETAILED DESCRIPTION

Hereinafter, certain embodiments will be described more fully with reference to the accompanying drawings. The invention described throughout this disclosure may, however, be embodied in many different forms and should not be construed as limited to the embodiments set forth herein; rather, these embodiments are provided by way of example so that this disclosure will be thorough and complete, and will fully convey the scope of the invention, such as it is defined in the appended claims, to those skilled in the art.

The term “coupled” is defined as connected, although not necessarily directly, and not necessarily mechanically. Two or more items that are “coupled” may be integral with each other. The terms “a” and “an” are defined as one or more unless this disclosure explicitly requires otherwise. The terms “substantially”, “approximately”, and “about” are defined as largely, but not necessarily wholly what is specified, as understood by a person of ordinary skill in the art. The terms “comprise” (and any form thereof, such as “comprises” and “comprising”), “have” (and any form thereof, such as “has” and “having”, “include” (and any form thereof, such as “includes” and “including”) and “contain” (and any form thereof, such as “contains” and “containing”) are open-ended linking verbs. As a result, a method that “comprises”, “has”, “includes” or “contains” one or more steps possesses those one or more steps, but is not limited to possessing only those one or more steps.

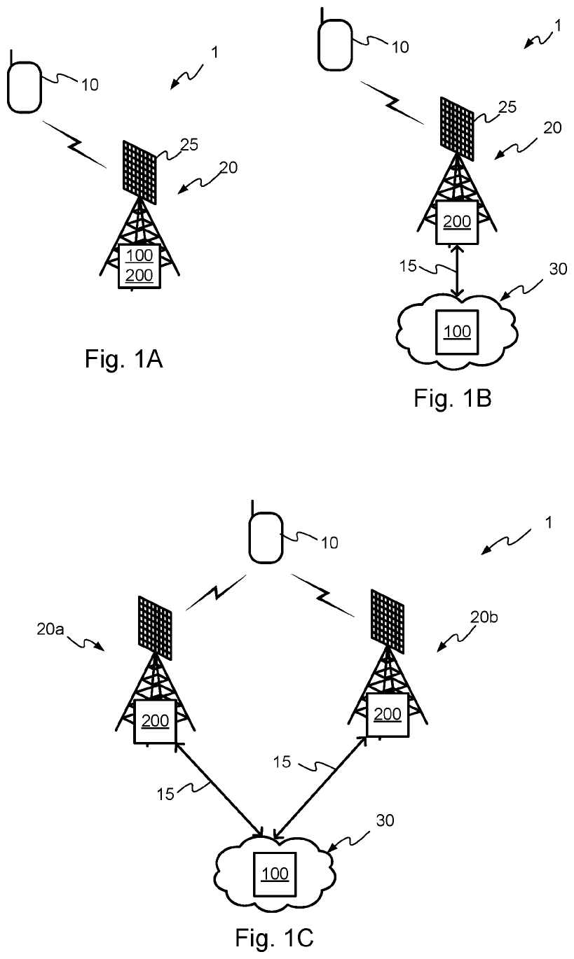

FIGS. 1A-C illustrates exemplary communication environments wherein embodiments of the present invention may be employed. A wireless communication device 10, or wireless device 10 for short, of a telecommunications system 1 or cellular communications system 1 is in wireless communication with a radio base station 20 of the cellular communications system 1. The wireless device 10 may be what is generally referred to as a user equipment (UE). The wireless device 10 is depicted in FIGS. 1A-C as a mobile phone, but may be any kind of device with cellular communication capabilities, such as a tablet or laptop computer, machine-type communication (MTC) device, or similar. Furthermore, a cellular communications system 1 is used as an example throughout this disclosure. However, embodiments of the present invention may be applicable in other types of systems as well, such as but not limited to WiFi systems. The radio base station 20 and wireless device 19 are examples of what in this disclosure is generically referred to as communication apparatuses. Embodiments are described below in the context of a communication apparatus in the form of the radio base station 20 or wireless device 10. However, other types of communication apparatuses may be considered as well, such as a WiFi access point or WiFi enabled device.

In FIG. 1A, the base station 20 comprises the previously presented Radio Unit (RU) 200 and a Distributed Unit (DU) 100. The base station 20 further comprises one or more antennas 25, in FIGS. 1A-C illustrated as antenna arrays, configured to wirelessly transmit and/or receive signals between the base station 20 and the wireless device 10.

In FIG. 1B, another example of the cellular communications system 1 is shown. In FIG. 1B, as in FIG. 1A, the RU 200 is located at the base station 20, or comprised in the base station 20, and proximal to the antenna 25. However, in FIG. 1B, the DU 100 is remote from the base station 20 and connected to the RU 200 by a communications interface 15.

In FIG. 1C, another example of the cellular communications system 1 is shown. In FIG. 1C, a first base station 20a and second base station 20b are both in communication with the wireless device 10. Each base station 20a, 20b comprises a respective RU 200 located close to the respective antennas 25 of the base stations 20a, 20b. Both the RUs 200 are in communication with a common DU 100 connected to the RUs 200 by a communications interface 15. In FIG. 1C, the DU 100 is shown as remote from both the first base station 20a and the second base station 20b, but may in some examples well be comprised in one of the base stations 20a, 20b as exemplified in FIG. 1A.

In FIGS. 1B-C, the DU 100 is shown as comprised in a cloud server 30, this is but one example and the DU 100 may be arranged at a bottom of the base station 20 and the DU at a top of the base station 20.

The communications interface advantageously utilizes a clock distribution protocol. The clock distribution protocol may be any suitable clock distribution protocol such as precision time protocols is or network time synchronization protocols. Such protocols are generally designed to synchronize the time across different devices in a network with high accuracy and precision. Some non-limiting examples of network time synchronization protocols are IEEE 1588 (also known as Precision Time Protocol or PTP), ITU-T PTP profile G.8275.1, and Network Time Protocol (NTP).

The teachings of the present disclosure are equally applicable to either of the exemplary cellular communications system 1 presented in reference to FIGS. 1A-C a

As a brief exemplary introduction in reference to FIG. 1C, assume that the communication between the DUs 200 is across a single frequency such that signals from each base station 20a, 20b are received in phase by the wireless device 10. This setup is sometimes referred to as a single frequency network, that is to say a network wherein multiple transmitters broadcast the same signal at the same frequency, creating a single network of synchronized signals. In order for the transmitted signals to be received at the same time at the wireless device 10, their respective transmission at the base stations 200a, 110b is advantageously synchronized to a common clock signal, a reference clock. The reference clock is a timing reference used to ensure that all transmitters in the network are precisely synchronized to each other. Generally each RU generates its own local clock signal, which is synchronized to the reference clock.

The DU 100 and RU 200 are synchronous with each other in order to support base station 20 transmissions in defined downlink slots and to be able to schedule the wireless device 10 to transmit in uplink slots. The slots are mapped into radio frames, generally with a duration of 10 ms. It is the phase of these radio frames that are synchronized between the DU 100 and RU 200. There is also a counter in each unit that count the radio frames with a cycle of 1024 frames and gives each frame a System Frame Number (SFN). Since slots are mapped into radio frames, this counter also counts fractions of Frames. The SFN counter may be seen as a fundamental clock of the base station 20.

To achieve precise synchronization, the reference clock signal is typically distributed to each RU 200 of the cellular communications system 1 using a high-speed data link, such as a dedicated fiber optic network or a wireless microwave link. This enables all RUs 200 to receive the reference clock signal with minimal delay and allows to the RUs 200 to accurately align their transmissions with each other.

However, the reference clock and its distribution is important to ensure signal quality and integrity at the receiving wireless device 10 as any timing errors or discrepancies between transmissions from the RUs may result in signal interference and degradation of reception quality. By using a common reference clock signal, it is possible to achieve seamless coverage over a large geographic area, even in challenging terrain or urban environments where traditional broadcasting methods may struggle to provide consistent coverage.

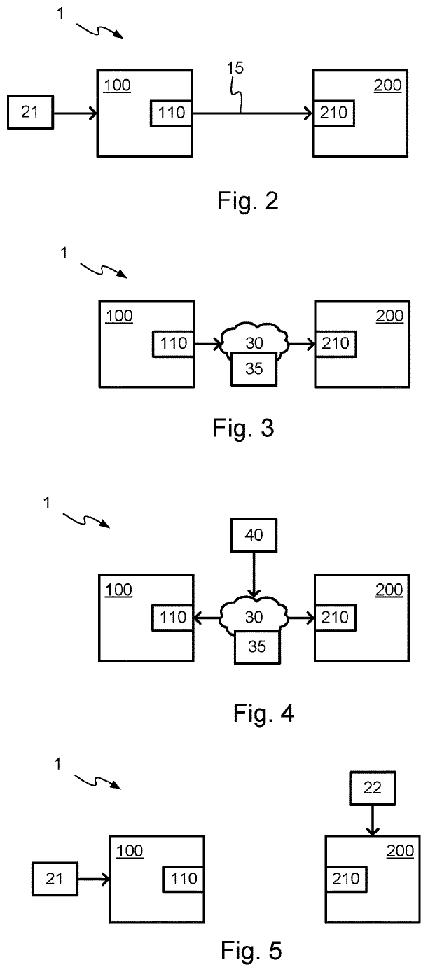

With reference to FIGS. 2-5, some examples of synchronization between RU 200 and DU 100 will be given. The exemplary synchronization methods are based on the specification O-RAN Control, User and Synchronization Plane Specification 10.0 which is hereby incorporated in full by reference. FIG. 2 shows time synchronization according to O-RAN L1-L2 Split Control (O-LLS C1), FIG. 3 shows time synchronization according to O-LLS C2, FIG. 4 shows time synchronization according to O-LLS C3 and FIG. 5 shows time synchronization according to O-LLS C4.

In FIG. 2 a synchronization method, O-LLS C1, is shown wherein control and synchronization signals are transmitted over the same link. In this approach, the control plane and synchronization information are carried together on the same communication channel. It simplifies the network architecture by using a single link for both control and synchronization purposes. As seen in FIG. 2, a direct connection between the DU 100 and the RU 200 is provided by a communications interface 15 that distributes a DU clock 110 from the DU 100 to the RU 200. An air interface clock 210 of the RU 200 is synchronized to the DU clock 110. Since the DU 100 is the source of synchronization, an accuracy of the DU clock 210 must be greater than a required accuracy of the air interface clock 210, i.e. the clock timing the signals to the antenna 25. O-LLS C1 may be considered a traditional way of synchronizing the clocks 110, 210 of the DU 100 and RU 200.

In FIG. 3 a synchronization method, O-LLS C2, is shown wherein control and synchronization signals are transmitted over separate links. The control plane signals are carried on one link, while the synchronization information is carried on another dedicated link. This separation allows for more flexibility in managing control and synchronization traffic. O-LLS C2 introduced a PTP Boundary Clock (BC) 35 between the DU 100 and the RU 200. In O-LLS C2, the DU 100 still distributes time to the RU 200, but in O-LLS C2, the PTP BC 35 re-distribute time with high accuracy between the DU 100 and RU 200. The PTP BC 35 receives the synchronization signals from the DU clock 110 and distributes them to the devices connected downstream, in FIG. 3, the RU 2000. The PTP BC 35 facilitates accurate and efficient propagation of time synchronization information by performing time translation, hierarchy management and fault isolation. In O-LLS C2, it should be mentioned that an accuracy of the DU clock 110 must be greater than a required accuracy of the air interface clock 210 as the PTP BC 35 will cause slight degradation from an accuracy budget during distribution of the DU clock 110. In FIG. 3, the PTP BC 35 is illustrated as forming part of a cloud server 30 or a cloud network. This is one example, and PTP BCs 35 may very well be implement at other locations in a network.

In FIG. 4, a synchronization method, O-LLS-C3, is shown wherein control signals are transmitted over one link, similar to O-LLS C2. However, the synchronization information is generated and distributed at the L2 (Layer 2) processing layer rather than being directly transmitted as a dedicated synchronization link. OLLS-C3 offers simplified synchronization distribution within the L2 processing layer. In O-LLS-C3, the DU clock 110 and air interface clock 210 is synchronized to a common reference clock 40. The common reference clock 40 is distributed by the assistance of PTP BCs 35 analogues to O-LLS C2. This architecture puts accuracy requirements on the reference clock 40 and the PTP BCs 35 provided between the DU clock 110 and the air interface clock 210 of the RU 200. Since time is distributed directly from the reference clock 40 to the RU 200, the accuracy requirements of the DU clock 110 may be relaxed.

The common reference clock 40 may be a grandmaster clock, sometimes known as a primary reference clock. Generally, a grandmaster clock is a time source that serves as the highest authority for time synchronization within a network. To this end, the grandmaster clock is advantageously designed to provide accurate time information. The grandmaster clock may, in some examples, rely on high-precision timekeeping mechanisms, such as atomic clocks or other advanced technologies, to achieve precise timekeeping within tight tolerances. The grandmaster clock may provide a time reference for the entire communications network 1. It should be mentioned that further grandmaster clocks may be provided for redundancy. These grandmaster clocks are advantageously configured in a fault-tolerant manner, where one grandmaster clock acts as the primary grandmaster clock, while others serve as backup grandmaster clock. This setup provides continuity in time synchronization even if one grandmaster clock fails.

In FIG. 5, a synchronization method, O-LLS-C4, is shown wherein control and synchronization signals are transmitted over separate links similar to O-LLS C2. However, the synchronization information may be sourced from an (common) external time source 21, 22, such as a Precision Time Protocol (PTP) network or a Global Navigation Satellite System (GNSS). The time source 21, 22 source provides highly accurate timing information to synchronize the DU clock 110 and the air interface clock 210. This means that, in O-LLS-C4, there is no requirement for time distribution between the RU 200 and the DU 100.

It should be mentioned that also in O-LLS-C2 and O-LLS-C3, the DU clock 110 is generally synchronized to the external time source 21, 22.

The O-LLS methods are not perfect. In O-LLS C2, the PTP BCs 35 between the DUs 100 and the RUs 200 will make automatic synchronization decisions. In doing the, the direct synchronization coupling between one DU 100 and its subtending RUs 200 is lost. This works well if there are no issues in the PTP BC 35 network since it is assumed all units will have the same time. However, in practice, in O-LLS C2, all RUs 200 will be synchronized by only one of the DUs 100. This means that any DUs 100 that are not synchronizing any RUs 200 must be synchronized to the same external time source 21, 22 as the DU 100 that controls the RUs 200. If the non-controlling DUs 100 are not synchronized from an external time source 21, 22 due to some external time distribution problems, the DU clocks 110 of these DUs 100 may end up out of synchronization with their subtending RUs 200.

In O-LLS C3, similar issues as those described with reference to O-LLS C2 are present. However, in O-LLS C3 none of the DUs 100 is controlling the sync of the RUs 200. The synchronization relies wholly on the functionality and operation of the PTP BC 35 network.

In O-LLS C4, it must be guaranteed the external time source 21, 22 is really common and accurately provided to both the DU 100 and the RU 200. The architecture is vulnerable to time distribution problems.

Specifically, in implementation wherein the DU 100 is implemented as a DU SW application that executes on a Common Off The Shelf (COTS) server, some conceptual problems are introduced when applying the ORAN synchronization architectures. Such an implementation is commonly known as Cloud RAN. It has been proposed by study group 9 in ORAN, that the synchronization architecture that best describes the Cloud RAN case is O-LLS-C3. O-LLS-C3 has the same issues in a cloud RAN as for a HW based DU 100. Further to this, the PTP synchronization of the DU 100 is separated from the synchronization of the air interface clock 210 of a radio network application. The radio network application is not able to synchronize PTP, it can only retrieve time from the server making the DU SW application an end point in a time distribution chain.

Further to this, there is also a problem with maturity of synchronization solutions for servers. Different vendors have different solutions, and the same vendor provide different solutions with different models and versions of their Network Interface Cards (NIC). One specific problem is that it seems very difficult to logically group several NICs to one PTP clock with a consistent accuracy and behavior.

The inventors behind the present disclosure have, through an inventive process, identified the drawbacks and shortcomings of the present solutions. Form this, the inventors have surprisingly, and despite technical prejudice, realized that, rather than synchronizing the air interface clock 210 to the DU clock 100, the DU clock 100 may be synchronized to the air interface clock 210. This addresses the risk of loss of synchronization between the DU 100 and its subtending RUs 200 of the O-LLS-C2-C4. This allows a SU SW application on a COTS server to be run independently of the synchronization capabilities of the COTS server. That is to say, a HW based DU 100, or a SW based DU 100 may be synchronized directly from its subtending RUs 200.

As mentioned, the air interface clock 210 (antenna interface) of the RU 200 has the most stringent synchronization requirements in the cellular communication system 1. For the present disclosure, the air interface clock 210 may be synchronized by any available method e.g., through a directly connected GNSS receiver, by highly accurate and reliable PTP time distribution, or a combination of these. Further to this, the DU 100 will have less stringent accuracy requirements if it is not included in the synchronization distribution path to the RU 200. As an effect of this, a time distribution protocol over IP (not relying on a time aware network) may be utilized to distribute the air interface clock 210 from the RU 200 to its parent DU 100. It should be mentioned that field experience of PTP over IP has demonstrated that this method gives sufficient accuracy despite some packet delay variation.

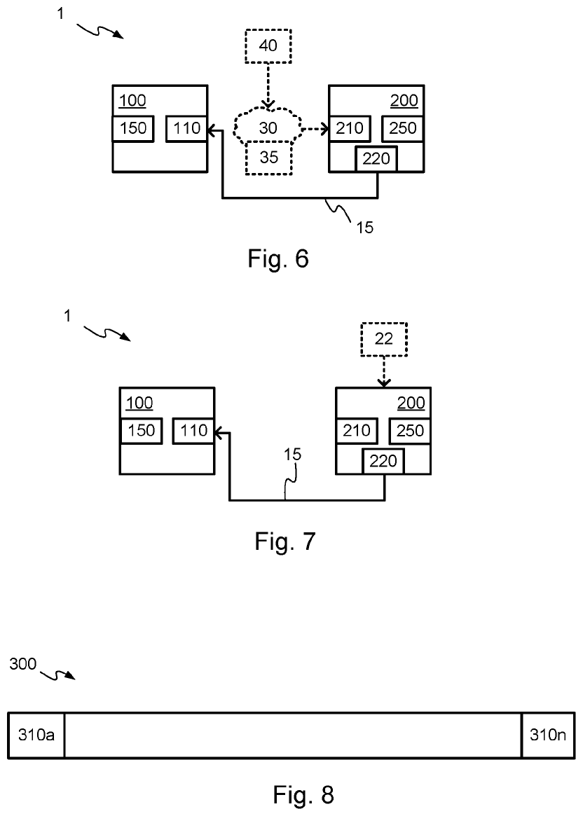

In FIG. 6, one exemplary block diagram of time synchronization in a telecommunications system 1 is shown. The telecommunications system 1 comprises a DU 100 and an RU 200 connected by a communications interface 15. The DU 100 comprises a DU clock 110 and processing circuitry 150. The RU 200 comprises an air interface clock 210 and processing circuitry 250. The air interface clock 210 is generally synchronous to the SFN counter which may be referred to as a clock time 220 of the telecommunications system 1. In FIG. 6, the air interface clock 210 of the RU 200 is synchronized to the reference clock 40 similarly to the synchronization method O-LLS-C3 described with reference to FIG. 4. One key difference between O-LLS-C3 and the solution of the present disclosure is that the DU 100 obtains the clock time 220 from the RU 200 and not from the reference clock 40.

In FIG. 7, another exemplary block diagram of time synchronization in a telecommunications system 1 is shown. The telecommunications system 1 comprises a DU 100 and an RU 200 connected by a communications interface 15. The DU 100 comprises a DU clock 110 and processing circuitry 150. In FIG. 7, the air interface clock 210 of the RU 200 is synchronized to the time source 22 similarly to the synchronization method O-LLS-C4 described with reference to FIG. 5. As in the example of FIG. 6, the DU 100 obtains the clock time 220 from the RU 200 over the communications interface 15. It should be mentioned that the time source 22 may be provided to the RU 200 via a direct interface such as a physical interface between a GNSS receiver of the RU 200 and the air interface clock 210.

The clock time 220 is generated at the RU 200 by synchronization to the air interface clock 210. The clock time 220 may be the air interface clock 210. As the clock time 220 is distributed to the DU 100, the accuracy requirements of the clock time 220 is lower than the accuracy requirement of the air interface clock 210. The timing accuracy requirements of the communications interface 15 between the DU 100 and RU 200 may be relaxed a simple clock distribution protocol may be utilized in place of the more complex PTP BC 35. Examples of clock/time distribution protocols are e.g. ITU-T PTP profile G.8275.1, IEEE 1588 (also known as Precision Time Protocol or PTP), Network Time Protocol (NTP), a proprietary protocol for exchanging time information, etc. As the skilled person will appreciate, with a standardized protocol, the air interface clock 210 (the SFN time) is advantageously converted to a standardized time format, while with a proprietary protocol, the SFN time may be used directly.

One feature of these time distribution protocols is that they make it possible to exchange time stamps upon reception and transmission. This is exemplified in FIG. 8, showing a general packet 300. The packet 300 comprises a start SFN value 310a, advantageously, at a start of the packet 300 and an end SFN value 310n, advantageously, at the end of the packet 300. By detecting a temporal delay between reception of the first SFN value 310a and the end SFN value 310n, a transmission time, and thereby a delay of the of the packet 300, and determining a difference between the end SFN value 310n and the communications interface 15 may be determined. This technique may be utilized both in transmission from the DU 100 to the RU 200, and in transmissions from the RU 200 to the DU 100 to determine the delay of the communications interface 15 in both directions. In other words, a UL temporal delay and/or a DL temporal delay may be determined based on two different SFN values 310a, 310n of the same packet 300. As previously mentioned, the SFN values 310a, 310 n are associated with the predetermined and well defined frame length (e.g. 10 ms) of the telecommunications system 1 which makes determining of the UL temporal delay and/or a DL temporal based on SFN values 310a, 310n accurate.

Historical implementations where the air interface clock 210 is synchronized to the DU clock 110, have generally assumed that uplink delay is the same as the downlink delay.

In addition to distributing the clock time 220, the RU 200 may further provide the DU 100 with an indicator for a status of a transmission buffer of the RU 200. This will enable the DU 100 to adjust a transmission rate and avoid a risk that transmission buffer of the RU over-run or under-run. This is not something that is provided in the O-LLS-C #presented with reference to FIGS. 2-5 and enables better utilization of the communications interface 15 as a risk for retransmissions and/or rejected packets 300 is reduced.

With reference to FIGS. 6 and 7, the DU 100 will be described in further detail. In some examples, the processing circuitry 150 of the DU is configured to obtain, or cause obtaining of, the clock time 220 from the RU 200. The processing circuitry 150 of the DU 100 is further configured to synchronize, or cause synchronizing of the DU clock 210 to the clock time 220. The processing circuitry 150 may be configured to obtain, or cause obtaining of, the clock time 220 based on SFN values 310a, 310n as presented herein. The processing circuitry may be configured to determine, or cause determining, of the UL temporal delay and/or the DL temporal delay of the communications interface 15 based on SFN values 310a, 310n. The processing circuitry 150 may be configured to monitor, or cause monitoring of, a buffer status of the RU 200, and control, or cause controlling of a transmission rate of the communications interface 15 based on the buffer status.

Causing something means that an entity (e.g. processing circuitry) or individual is taking actions that result in a method or action being performed, but may not directly perform the method or action themselves. The entity or individual may be enabling, controlling, or initiating the performance of the method or function by others. This is different from performance of the method or function which involves the actual execution or implementation of the method or function. This may involve human intervention, the use of specific tools or devices, the execution of computer instructions etc.

In some embodiments, the DU 100 is remote from the RU 200. In some embodiments, the DU 100 is a SW implemented DU running on a COTS server, advantageously on a cloud server. The cloud server may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc.

With further reference to FIGS. 6 and 7, the RU 100 will be described in further detail. In some examples, the processing circuitry 250 of the RU is configured to provide, or cause providing of, the clock time 220 from to the DU 100. The processing circuitry 250 may be configured to provide, or cause providing of, the SFN values 310a, 310n to the DU 100. The processing circuitry 250 provide, or cause providing of, a buffer status (or an indication of the buffer status) of the RU 200, to the DU 100.

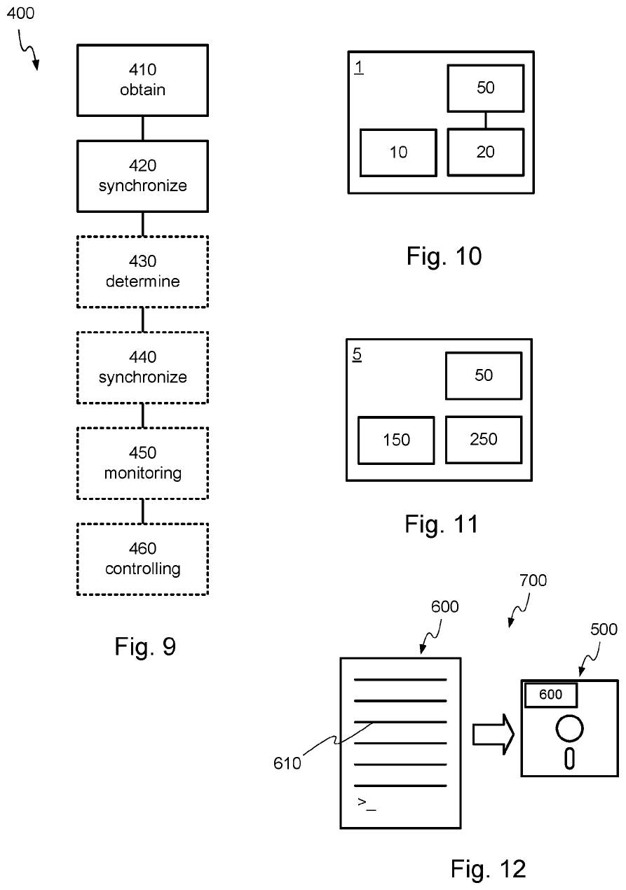

In FIG. 9, a method 400 of time synchronization in a telecommunications system 1 is shown.

The method is advantageously, but not necessarily, a computer-implemented method 400. As is commonly known, a general method refers to a process or technique that may be performed or carried out using any suitable means, without any specific reference to a particular technology or device. It typically describes a series of steps or actions to achieve a desired outcome. Methods are generally not tied to any specific implementation and can be executed manually, using traditional tools, or through any appropriate means. A computer-implemented method, as the name suggests, involves the use of a computer or a computing device such as a processor, processing circuitry etc. to perform the steps or actions of the method. A computer-implemented method generally involves execution of instructions or algorithms by a computer processor to achieve a specific result. To this, in examples wherein the method 400 is a computer-implemented method, it is advantageously executed by one or more suitable processing circuitry 50, 150, 250.

The method 400 may comprise any feature, example or function presented herein. The method 400 is concerned with time synchronization between a DU 200 and an RU 200. The DU 100 and the RU 200 may be any DU or RU presented herein. The DU 100 and RU 200 are connected by a communications interface 15 and the time synchronization is provided across the communications interface 15. The communications interface 15 may be any suitable communications interface 15. Advantageously, distribution of time and clock information across the communications interface 15 is provided by a clock distribution protocol, specifically a clock distribution protocol mentioned in the present disclosure.

The method 400 comprises obtaining 410, by the DU 100, a clock time 220 provided by the RU 200. The clock time 220 is advantageously provided via the clock distribution protocol across the communications interface 15. The method 400 further comprises synchronizing 420 the DU clock 110 to the clock time 220. Advantageously, in some examples, the clock time 220 is synchronized to the air interface clock 210 of the RU 200. Further to this, the method 300 may comprise synchronizing 440 the air interface clock 210 to a reference clock 20, 22. Advantageously the air interface clock 210 is synchronized to the reference clock 40 via a precision time protocol, preferably ITU-T PTP profile G.8275.1. As previously mentioned, the reference clock 40 may be a grandmaster clock.

The method 400 enables a comparably high accuracy clock of the RU 200 to provide a reference clock for the DU 100. This allows for simpler implementation of the DU 100 with reduced timing requirements and lower HW cost due to relaxed constraints. A risk that the DU 100 and RU 200 should fall out of synchronization is further reduced compared to prior art solution.

As previously mentioned, optionally, in some examples, the clock time 220 may be obtained based on SFN, values 310a, 310n. Advantageously, at least two different SFN values 310a, 310n associated with a same data packet 300 in which case the method 400 may further comprise determining 430 an UL temporal delay based on the at least two different SFN values 310a, 310n. Alternatively, or additionally, in some examples, the method 400 may further comprise determining 430 a DL temporal delay of the communications interface 15 based on the at least two different SFN values 310a, 310n. This allows the UL temporal delay to be determined independently of the DL temporal delay and/or the DL temporal delay to be determined independently of the UL temporal delay.

In order to reduce a risk of buffer underflow or underflow of transmit and/or receive buffers of the RU 200, the method 400 may advantageously comprise monitoring 450 a buffer status of the RU 200, and controlling 460 the transmission rate of the communications interface 15 based on the buffer status.

In FIG. 10, a block diagram of the telecommunications system 1 is shown. The telecommunications system 1 comprises the wireless device 10, the base station 20 and processing circuitry 50. The processing circuitry 50 is operatively connected to at least the base station 20, and thereby the DU 100 and RU 200 of the base station. The processing circuitry 50 is advantageously configured to execute, or cause execution, of the method 400 described with reference to FIG. 9.

In FIG. 11, a block diagram of a computer system 5 is shown. The computer system 5 comprises at least one of the processing circuitry 50 of the telecommunications system 1, the processing circuitry 150 of the DU 150 or the processing circuitry 250 of the RU. The computer system 5 is advantageously configured to execute, or cause execution, of the method 400 described with reference to FIG. 9.

In FIG. 12 a computer program product 700 is shown. The computer program product 700 comprises a computer program 600 and a non-transitory computer readable medium 500. The computer program 600 is advantageously stored on the computer readable medium 500. The computer readable medium 500 is, in FIG. 12, exemplified as a vintage 5.25″ floppy disc, but may be embodied as any suitable non-transitory computer readable medium such as, but not limited to, hard disk drives (HDDs), solid-state drives (SSDs), optical discs (e.g., CD-ROM, DVD-ROM, CD-RW, DVD-RW), USB flash drives, magnetic tapes, memory cards, Read-Only Memories (ROM), network-attached storage (NAS), cloud storage etc.

The computer program 600 comprises instruction 610 e.g. program instruction, software code, that, when executed by processing circuitry cause the processing circuitry to perform the method 400 described herein with reference to FIG. 9.

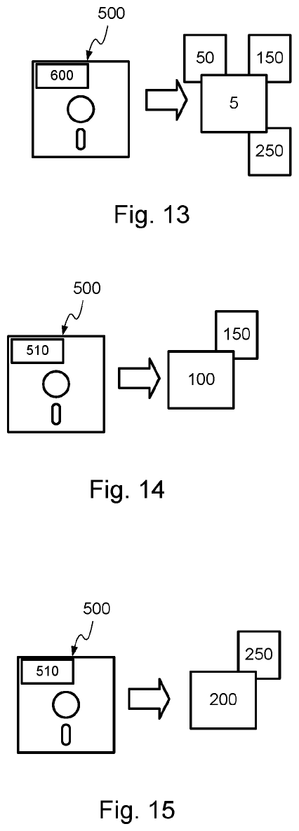

As shown in FIG. 13, the computer program 600 may be loaded into the computer system 5 and cause one or more of the processing circuitry 50, 150, 250 to perform the method 400 presented in reference to FIG. 9.

As shown in FIG. 14, the computer program 600 may be loaded into the DU 100 and cause the processing circuitry 150 of the DU 100 to perform at least part of the method 400 presented in reference to FIG. 9.

As shown in FIG. 15, the computer program 600 may be loaded into the RU 200 and cause the processing circuitry 250 of the RU 200 to perform at least part of the method 400 presented in reference to FIG. 9.

Modifications and other variants of the described embodiments will come to mind to one skilled in the art having benefit of the teachings presented in the foregoing description and associated drawings. Therefore, it is to be understood that the embodiments are not limited to the specific example embodiments described in this disclosure and that modifications and other variants are intended to be included within the scope of this disclosure. For example, while embodiments of the invention have been described with reference one DU serving one RU, persons skilled in the art will appreciate that the embodiments of the invention can equivalently be applied to networks wherein one DU serve a plurality of RUs. Furthermore, although specific terms may be employed herein, they are used in a generic and descriptive sense only and not for purposes of limitation. Therefore, a person skilled in the art would recognize numerous variations to the described embodiments that would still fall within the scope of the appended claims. Furthermore, although individual features may be included in different claims (or embodiments), these may possibly advantageously be combined, and the inclusion of different claims (or embodiments) does not imply that a combination of features is not feasible and/or advantageous. In addition, singular references do not exclude a plurality. Finally, reference signs in the claims are provided merely as a clarifying example and should not be construed as limiting the scope of the claims in any way.

1. A method of time synchronization in a telecommunications system between a distributed unit (DU) and a remote unit (RU) connected by a communications interface, the method comprising:
obtaining, by the DU, a clock time provided by the RU via a clock distribution protocol, and
synchronizing a DU clock to the clock time provided by the RU.

2. The method of claim 1, wherein the clock time is synchronized to an air interface clock of the RU.

3. The method of claim 2, wherein the clock time is obtained based on system frame number (SFN) values.

4. The method of claim 3, wherein at least two different SFN values associated with a same data packet are obtained and the method further comprises:
determining a UL temporal delay and a DL temporal delay of the communications interface based on the at least two different SFN values.

5. The method of claim 4, wherein the UL temporal delay is determined independently of the DL temporal delay and the DL temporal delay is determined independently of the UL temporal delay.

6. The method claim 2, further comprising:
synchronizing, by the RU, the air interface clock to a reference clock.

7. The method of claim 6, wherein the air interface clock is synchronized to the reference clock via a precision time protocol, preferably ITU-T PTP profile G.8275.1.

8. The method of claim 6, wherein the reference clock is a grandmaster clock.

9. The method of claim 6, wherein the air interface clock is synchronized to the reference clock via a direct interface of the RU.

10. The method of claim 9, wherein the reference clock is obtained from a GNSS receiver of the RU.

11. The method of claim 1, further comprising:
monitoring a buffer status of the RU, and
controlling a transmission rate of the communications interface based on the buffer status.

12. The method claim 1, wherein the method is a computer-implemented method.

13. A distributed unit (DU) operatively connected to a remote unit (RU) by a communications interface, the DU comprising a DU clock processing circuitry configured to cause:
obtaining of a clock time provided by the RU via a clock distribution protocol, and
synchronizing of the DU clock to the clock time provided by the RU.

14. The DU of claim 13, wherein the clock time is an air interface clock of the RU.

15. The DU of claim 14, wherein the clock time is obtained based on system frame number (SFN) values.

16. The DU of claim 15, wherein the processing circuitry is further configured to cause:
determining of a UL temporal delay and a DL temporal delay of the communications interface based on the at least two different SFN values.

17. The DU of claim 13, wherein the processing circuitry is further configured to cause:
monitoring of a buffer status of the RU, and
controlling of a transmission rate of the communications interface based on the buffer status.

18. The DU of claim 13, wherein the processing circuitry form part of a computer system.

19. The DU of claim 18, wherein the computer system is a cloud based computer system.

20.-23. (canceled)
